(19) United States
(12) Patent Application Publication
(10) Pub. No.: US 2007/0137497 A1
(43) Pub. Date: Jun. 21, 2007

(54) Convection fryer with convenient filter and oil treatment provisions

(76) Inventors: Steven J. Savage, Concord, NH (US); Nathaniel A. Lambert, Hooksett, NH (US)

Correspondence Address: BRINKS HOFER GILSON & LIONE, P.O. BOX 10395, CHICAGO, IL, 60610, US

(21) Appl. No.: 11/590,567

(22) Filed: Oct. 31, 2006

Related U.S. Application Data
(60) Provisional application No. 60/733,539, filed on Nov. 4, 2005.

(51) Int. Cl. A47J 37/12

(52) U.S. Cl. 99/403

(57) ABSTRACT

A fry cooker uses a flow of cooking oil or other medium during the cooking operation to strain out or screen particles that cause degradation of the cooking oil or medium. There are several configurations of the fryer that achieve this result. One is a fryer with a first coarse strainer and a second fine sieve or screen. The first screen is used to swiftly screen and separate coarse particles. The second is used as a finer filter to separate finer particles. Either screen may also be adapted to hold a packet for chemically treating and preserving the cooking medium. Another configuration may include a fryer basket that has a straining portion for removing particulates from the cooking medium. The basket may have an upper sealing portion and a lower straining portion.

### CROSS REFERENCE TO RELATED APPLICATIONS

This application claims priority from provisional application Ser. No. 60/733,539, filed on Nov. 4, 2005, which is fully incorporated by reference herein.

### FIELD OF THE INVENTION

The field of the invention is that of convection fry cookers, methods of using such fry cookers, and filtering the oil used in such fry cookers.

### BACKGROUND

Convection fry cookers or fryers are used extensively in the preparation of food in restaurants, bakeries, institutions, and other outlets. Baked goods, such as fritters, vegetables, such as French fries, and even entrees, such as chicken or fish, are prepared by immersion in very hot oils. The food is fried for a period of time until it is considered “done.” The degree of “doneness” may be ascertained by watching the food product to see if a certain change of color takes place. Most often, however, an operator simply fries products for a given time at a given temperature, and considers the food as “done” after that period of time.

One problem in the use of fry cookers is degradation of the oil caused by being held at an elevated temperature for long periods of time. The oil is believed to degrade into undesirable fatty acid by-products after being held at a high temperature for a sufficiently long period of time, i.e. several hours. Of course, oils, such as vegetable oils, are not the only cooking medium. For instance, lard, fat, shortening, and or other cooking media may be used. Any of these will suffice as a cooking medium.

Another problem is contamination by the food itself. When food products are added to the fryer, small particles are inevitably separated from the products, such as agglomerated flour or breading from chicken or fish, or small bits from French fries or fritters. These small particles are not undesirable in themselves, since in general they are made from the same materials and foods that the operator intends to cook. However, broken off and in small pieces, these particles tend to remain in the hot oils for much longer periods of time because they cannot be easily removed.

Previous efforts to filter out these particles have involved a variety of solutions. For instance, U.S. Pat. No. 3,839,951 uses an in-line filter for removing particulates from the oil. However, this patent requires a separate vessel for filtering the particulates, which may not be readily accessed during operation. U.S. Pat. No. 5,404,799 has an in-line filter at the bottom of the cooking vat. It will clearly be very difficult to service this filter on a timely basis, and certainly not during any cooking operation. U.S. Pat. No. 6,095,037 includes replaceable filter bags and a unique U-shaped fire tube that aids in heat transfer and operation of the unit. This unit requires continual replacement of the filter bags and may thus be expensive for continuous operation. What is needed is an inexpensive and yet easy and effective method to remove small particles from the cooking oil in a convection type fryer.

### BRIEF SUMMARY

One embodiment of the invention is a fryer or fry cooker. The fryer includes a vat with a first portion for holding a cooking medium, an energy source for heating the cooking medium, and a pump for circulating the cooking medium during a cooking cycle. The fryer also includes a control system including a microprocessor controller for controlling the energy source and the pump. The fryer also includes at least one at least one strainer for use in a second portion of the vat for filtering the cooking medium while the cooking medium is being pumped, wherein the strainer may be quickly removed and emptied while the medium is being pumped.

Another embodiment of the invention is a method of operating a fryer, such as the one described above. The method includes heating the cooking medium to a temperature suitable for cooking food, pumping the cooking medium to achieve a flow from the first portion of the vat to the second portion of the vat, and straining the cooking medium by flowing the cooking medium through at least one strainer. The method also includes a step of emptying the strainer. The step of emptying the strainer may be accomplished while the cooking cycle continues unabated, or the strainer may be emptied later.

Another embodiment is a fryer. The fryer includes a vat for holding a cooking medium, an energy source for heating the cooking medium, a pump for automatically circulating the cooking medium during a cooking cycle, and a control system for controlling at least the energy source. The fryer may also include a cooking basket with a sealing portion and a straining portion, wherein the cooking basket collects cooking particles from the medium during the cooking cycle.

Another embodiment is a method of operating a fryer as described above. The method includes heating the cooking medium to a temperature suitable for cooking food, automatically pumping the cooking medium to achieve a flow through the cooking basket, and then straining the cooking medium by flowing the cooking medium through the straining portion of the cooking basket. The method also includes emptying the straining portion.

Another embodiment is a fryer basket. The fryer basket is used to fry foods in a fryer or fry cooker. The fry basket includes an upper portion for sealing, a lower portion for filtering, and a bottom portion for filtering. The basket also includes a handle connected to at least the upper and lower portions. There are many embodiments of the invention, only a few of which are described and pictured herein. It is intended that the drawings and descriptions below be illustrative of the invention rather than limiting.

### BRIEF DESCRIPTION OF THE DRAWINGS

FIG. 1 is an isometric view of a fryer embodiment;

FIG. 2 is a plan view of the embodiment of FIG. 1;

FIGS. 3a and 3b are side views of embodiments of fryers;

FIG. 4 is an isometric view of another fryer embodiment;

FIG. 5 is a fryer basket for use with the fryer of FIG. 4;

FIGS. 6a and 6b are side views of fryer embodiments;

FIG. 7 depicts another fryer embodiment with a crumb dump;

FIG. 8 is an isometric view of a basket lift for use on fryers;

FIG. 9 is a side view of a high-temperature pump and motor for use on a fry cooker; and

FIG. 10 is an exploded view of a high temperature pump and motor.

### DETAILED DESCRIPTION OF THE DRAWINGS AND THE PRESENTLY PREFERRED EMBODIMENTS

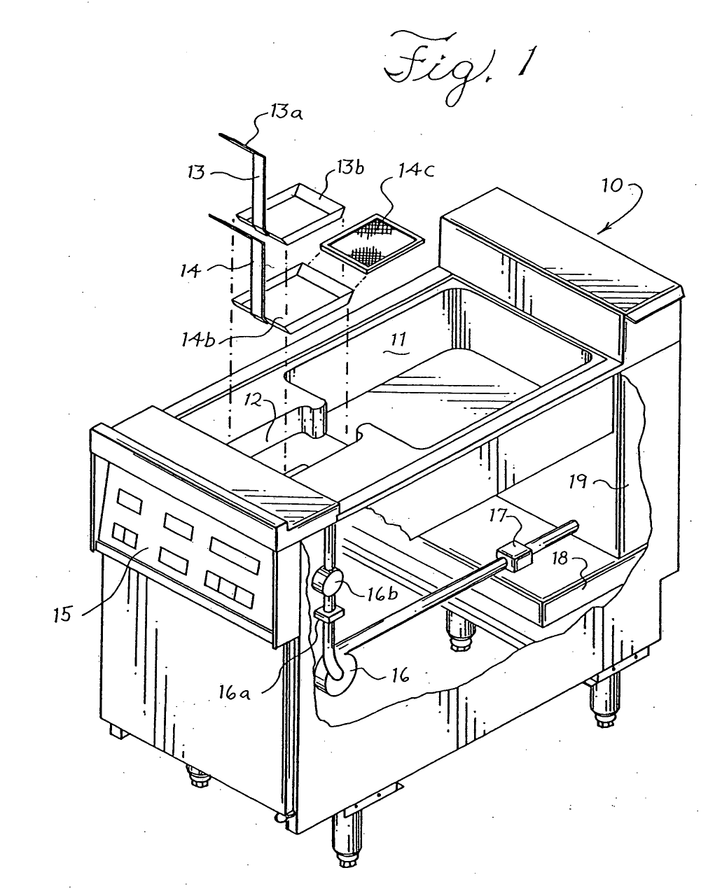

There are many embodiments of the present invention. FIG. 1 is an isometric view of a first embodiment. Fryer 10 includes a fry vat 11, the vat including the area in which hot oil, preferably in the range of 320° F. to 390° F., is held to cook food. Other temperatures may be used as desired. Operation of the fryer is controlled by integral control panel 15, which includes the necessary controllers, switches and relays for operating pump 16, heater or combustion system 18, and other valves and control elements used by the fryer. Control panel 15 also receives signals from sensors or other instruments at various locations in the fryer, and may include read-outs for the convenience of the fryer operators. The proximal end of vat 11 includes a second, overflow portion 12. During operation of fryer 10, oil is intended to flow from vat 11 to overflow portion 12, so that hot oil impinges on primary straining screen 13 and secondary straining screen 14, which are normally kept in overflow portion 12. Oil is thus filtered or screened through screens 13, 14 before the oil is led to pump 16. One additional screen or strainer 16a is placed in-line upstream of pump 16, along with valve 16b. This screen, which may be cleaned periodically, such as once or twice per day, helps to insure that food particles do not reach pump 16, and do not cause the pump to clog.

Pump 16 then pumps the filtered or screened oil for heating by the combustion system 18. Pumps used for fry cookers are preferably low flow, low head, positive displacement pumps, such as gear pumps or vane pumps. Other pumps may be used, such as peristaltic pumps, or even centrifugal pumps. Certain positive displacement pumps, such as gear pumps, are preferred, because their rate of flow may be more readily controlled. In addition, maintenance on such pumps, which are pumping hot oil at temperatures as high as 380-390° F. or higher, is desirably low, while their reliability is assured and their repair costs are low.

In this embodiment, there is also a heat exchanger 19 to which freshly heated oil is first sent before returning to vat 11. It is preferable for overflow portion 12 to be very close to vat 11 so that a minimum of heat and energy is lost while the oil or cooking medium flows through both. The closeness is desirable in order to minimize the heat transfer area for the cooking vat and the overflow or straining area. The two may be made from a single stamping, or they may be made separately and subsequently connected in a manner to minimize the distance between them. This will also minimize heat losses for oil or cooking medium passing through them.

Straining Screens

Primary straining screen 13 is preferably made of a stainless steel handle 13a and stainless steel wire mesh 13b, preferably about 20 mesh using 0.018 diameter wire in a square weave pattern. The mesh may be larger or smaller than the preferred embodiment, but the primary straining screen is intended to catch larger particles that are easy to catch, but which, because of their size, could cause gross contamination of the cooking oil. During operation of the fryer, and preferably not during the time when food is actually being fried, screen 13 may be lifted from the fryer and the contents discarded quickly and easily, with loss of a very minimal amount of cooking oil. The amount of oil lost is minimal because the screen holes are large and the screen is intended to drain quickly, rather than retaining oil on the mesh. In this embodiment, the screen is preferably placed so that retaining wire mesh 13b is normally immersed in the cooking oil.

Secondary straining screen 14 is also preferably made of a stainless steel handle 14a and stainless steel wire mesh 14b, in which the wire mesh is much finer, preferably a true filter mesh, such as a 30×150 Dutch weave able to retain 95-115 micrometer particles. These smaller openings will catch much finer particles and agglomerates. Secondary straining screen 14 preferably is physically larger in area, with a larger surface area for straining and filtering.

Primary straining screen 13 preferably fits within secondary straining screen 14. Just as a user is able to lift primary straining screen 13, drain off hot oil, and discard large contaminants, a user is also able to lift secondary straining screen 14. In this instance, the screen is much finer, and will require the user to pause for a longer period of time for oil to drain off secondary straining screen 14. The user then discards finer contaminants.

Filter Aids

It will be recognized that a filter aid 14c may also be used, preferably with secondary straining screen 14 but also with primary straining screen 13. Filter aid 14c may be in the form of a relatively flat sheet, or it may have the pillow-shape of the top or bottom of either of the primary or secondary straining screens, so that a small amount of oil is retained on the top of the filter aid, giving the hot oil a longer residence time as it passes through the filter aid.

The filter aid may be nothing more than a cotton pad, a cellulose filter pad, or other paper or fibrous medium, to filter oil while retaining desirably small particulates and contaminants. The filter may be made from paper, rayon, PTFE (such as Teflon®-like compound), polyester or other suitable material. The filter aid may also include a chemical designed to treat frying oil. These chemicals include magnesium sulfate, sold under the trade name Magnesol®, or other treatments or fine filter media, such as activated carbon or diatomaceous earth. In general, these treatments tend to remove undesirable by-products, such as free fatty acids, oxidized fatty acids, or other products of degradation, by reacting the acids or by-products or otherwise entrapping them so that they can be removed from the cooking medium. The packet may then be regenerated, or more usually, disposed of and replaced.

Products used as part of the filter aid to absorb or eliminate products of degradation include magnesium silicate, such as Magnesol® mentioned above. Other possibilities include calcium silicate, silica and silica gel, basic pH alumina, and bleaching earths. Silica products that are potentially useful in these applications include Britesorb oil purifiers from PQ Corp., Valley Forge, PA, and Trisyl Silica, from Grace Davison Products, Baltimore, MD. Other products may be used.

Additional views of fryer vats with a filtering portion

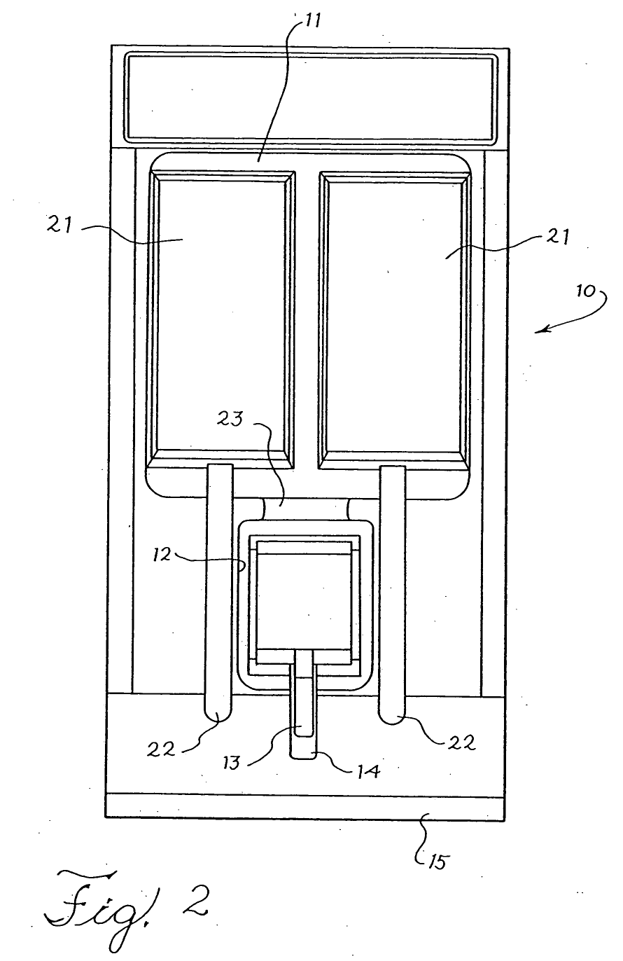

FIG. 2 depicts a top or plan view of fryer 10 of the embodiment described in FIG. 1. The fry baskets 21 cover most of the surface area of the cooking vat 11. A separating channel 23 leads from cooking vat 11 to overflow area 12 toward the front of the fryer. A user or an operator of the fryer operates the fryer using control panel area 15 and maneuvers baskets 21 by using handles 22, the handles preferably separated a distance from cooking vat 11. Oil flows from vat 11 through the separating channel 23 and into the overflow area 12. As the oil flows, it passes through primary straining screen 13 and secondary straining screen 14.

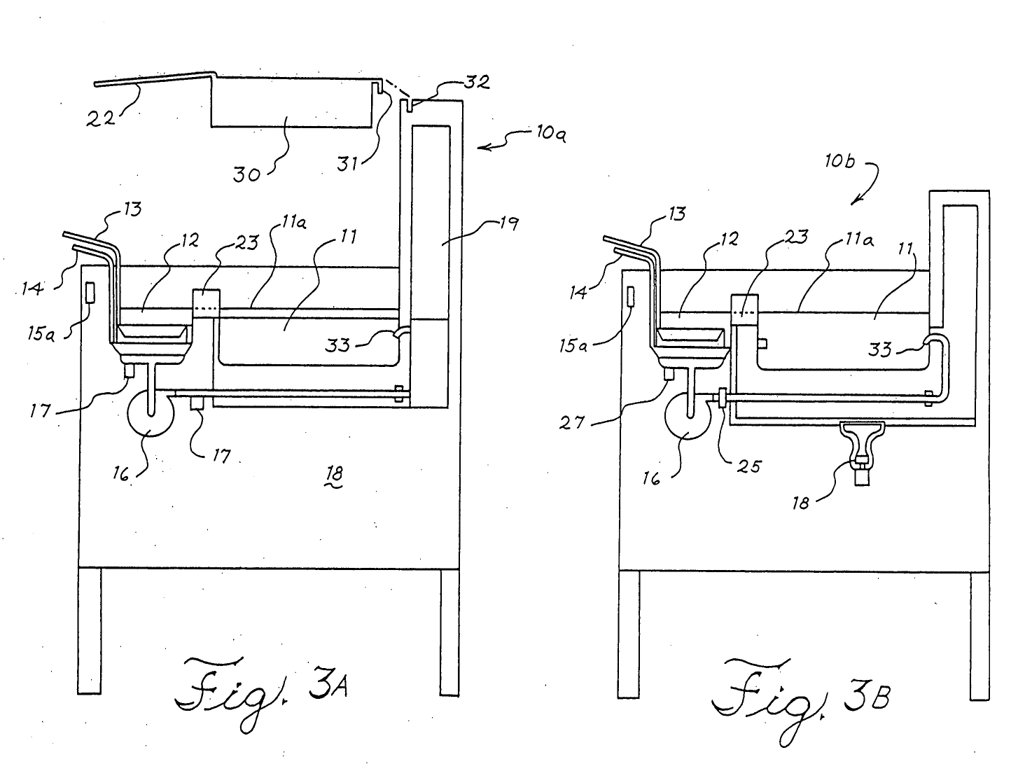

FIG. 3a depicts a side view of fryer 10a, an embodiment very similar to fryer 10 in FIG. 1. Fryer 10a includes a vat 11, separating channel 23, and an over flow area 12. Inside overflow area 12 rest primary straining screen 13 and secondary straining screen 14. In addition, as part of the controls for the fryer, there are pressure sensors 17 near the inlet and outlet of oil pump 16. Alternatively, the control system may use a pressure difference sensor (delta-P sensor) with pressure taps as shown, before and after the pump. Note that in FIG. 3a the flow of cooking oil is from the overflow area to the pump and then to heat exchanger 19, where heat is added by combustion system 18. There may also be a valve 33 between heat exchanger 19 and vat 11.

A properly functioning pump will have a relatively dependable difference in pressure caused by the pump. In a situation in which either or both of the screens becomes clogged, the pump will have little pressure on the outlet, and thus may have a reading different from that pressure difference sensed during normal operation. The control system may have a microprocessor controller 15a to which the sensors are operably linked, and may sound or signal an alarm or shut down the pump when the sensor readings are out of the normal operating range.

Fryer 10a includes a combustion system 18 for heating oil inside a heat exchanger 19. In FIG. 3a, the combustion system, under the control of microprocessor controller 15a, is depicted as operating on natural gas or other fossil fuel, such as LP gas. Note that in FIG. 3b, the flow of oil is from the overflow area to the pump, and then through a pipe directly to vat 11. Combustion system 18 is intended to directly heat vat 11. In other embodiments, the fryer could be heated by electric heaters immersed in a deeper vat or in a heat exchanger adjacent to the vat. In another embodiment, a combustion heater with a fire or heating tube may be immersed in a deeper vat or in a heat exchanger in fluid communication with the vat. In another embodiment, fryer 10b is similar to fryer 10, but includes temperature elements or sensors 27, spaced as shown, in the vat 11, in the overflow area 12. Microprocessor controller 15a controls the fryer using readings from the temperature elements.

In addition, fryer 10b may have a flow sensor 25, to insure that the screens 13, 14 are not clogged and that the flow of oil continues. Flow sensor 25 is operably connected to microprocessor controller 15a. Flow sensor 25 may be a capacitive sensor, an ultrasonic-type mass flow sensor, or any other mass or flow sensor. The flow sensor may be any applicable type of mass or flow sensor, such as a paddle-wheel type sensor, a turbine meter, a Coriolis-type mass flow sensor, and so forth. In addition, flow may be monitored by using temperature sensors or pressure difference sensors. If flow is present, temperature sensors on either side of a pump have readings that are close to each other, while pressure sensors will have readings that are different, because of the additional head added by the pump. By a flow sensor is meant an instrument or combination of instruments that will quickly and readily allow an operator or a control system to determine whether flow is present, and to quantify that flow to an extent necessary to control a heat source, a pump, or both. Non-contacting flow sensors, i.e., those that do not have a part directly in contact with hot oil, are preferred. Other sensors, such as pressure or pressure difference sensors, desirably have only a very small portion, such as a membrane cover, in direct contact.

The straining screens also allow for scraping and cleaning of the vats 11 while the oil and the vats are hot. This allows for the easiest and quickest cleaning of the walls of the vat, while the constant flow of oil insures that the scrapings will be immediately swept into the screens.

As depicted in FIG. 3a, it may be desirable to include as part of the fryer a higher back portion with a fixture 32 for holding a fry basket 30 by means of a hook 31 or extension. One way of operating the fryer is to remove the fry basket 30, holding food that has just been cooked (not shown), and to hang the basket using extension 31 on a rear of the fryer using a receptacle or fixture 32 that accepts extension 31. After the basket is removed, it may be desirable for the basket to rest for 10-20 seconds while excess cooking oil drains back into vat 11.

Fryers with automatic pumping adapted for use with a filtering basket

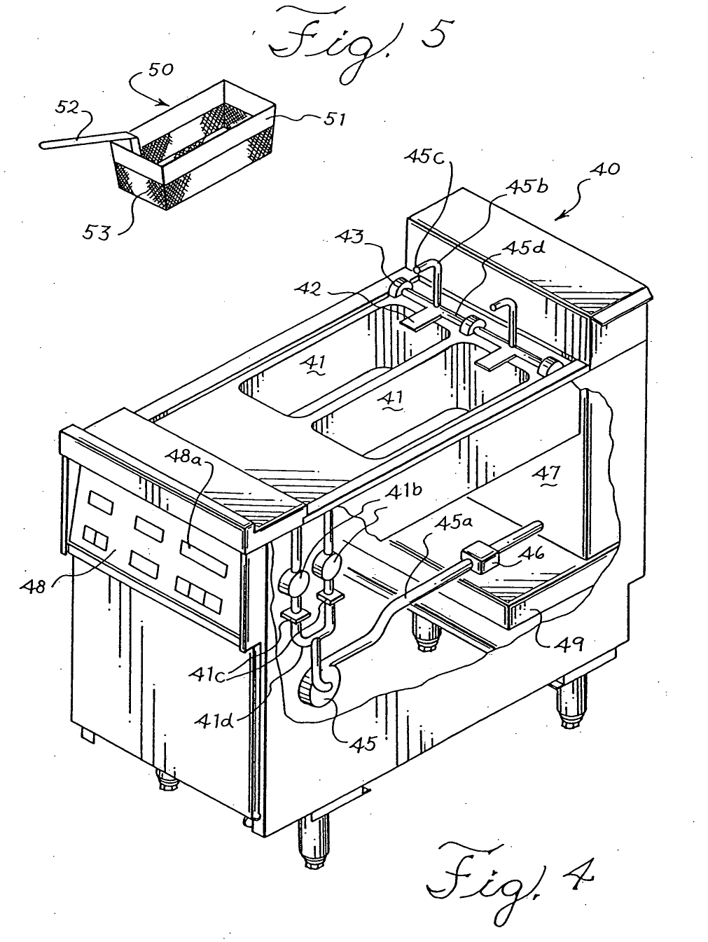

Other embodiments may use less oil than the embodiments depicted in FIGS. 1-3b. FIGS. 4, 5, and 6a-6b use a vat or well of oil about the size of the cooking basket so that the least possible amount of oil is used. FIG. 4 depicts a fryer embodiment designed for the special fryer basket of FIG. 5. The fryer of FIG. 4 may of course be used with other baskets, but it is highly advantageous to use the basket of FIG. 5. Fryer 40 includes a desired number of wells 41, one for each basket of food for which cooking is desired at the same time. Each well is plumbed with a drain pipe 41a, a valve 41b, and a strainer 41c for trapping food bits and particles. The strainers may be cleaned periodically, such as once or twice a day. Y-joint 41d connects the oil well drains to pump 45.

Oil is pumped by pump 45 through piping 45a connected to a heat exchanger 47, which contains a reservoir of heated oil. The pump then pumps oil through one or more inlet pipes 45b and inlet nozzles 45c. The operator controls fryer 40 using control panel 48 and a microprocessor controller 48a, flow sensor 46, and a number of other sensors and control elements as shown below. The oil is heated by combustion system 49.

Each inlet pipe 45b and nozzle 45c may be pivotally mounted on blocks 43 through non-oil flowing segments 45d mounted to fryer 40. When a fry basket is placed into well 41, the fry basket impinges on tab 42, causing pipe 45b and nozzle 45c to rotate downward. Each segment with a tab 42, inlet pipe 45b, and nozzle 45c is independent of each other segment, and may be pivoted separately. Blocks 43 are preferably stationary, and segments 45d are preferably spring-mounted, as mentioned above, so that when there is no restraining force on tab 42, such as a fryer basket, the segments of pipe automatically rotate upwards as shown in FIG. 4. In other embodiments, pipe 45b and nozzle 45c may be located at an opposite end of the well, or in another portion of the well, so that nozzle 45c may still be placed under the surface of the oil or other cooking medium in the well. Ensuring that the nozzle is beneath the surface helps in avoiding splashing and also assists with the flow of the cooking medium.

Fryer basket 50 is preferably made from stainless steel or other material acceptable for direct food contact, and which is long-lasting and easy to clean. Basket 50 includes an upper impermeable or sealing portion 51, a lower screen mesh portion 53, and a handle 52. The upper portion is preferably made from sheet metal, and the lower portion is preferably made from stainless steel mesh, as discussed above for previous embodiments. Using this basket, and other embodiments, oil does not flow merely from gravity. Instead, the discharge pressure of the pump causes oil to flow from the pump to the oil reservoir or heat exchanger. Because of the basket design, the suction pressure of the pump, a partial vacuum, also causes oil to flow from the basket and vat into the inlet of pump. This partial vacuum may be used so long as the level of oil in well 41 is kept above the bottom of sealing portion 51 of the basket.

Additional view of fryers with automatic pumping and filtering baskets

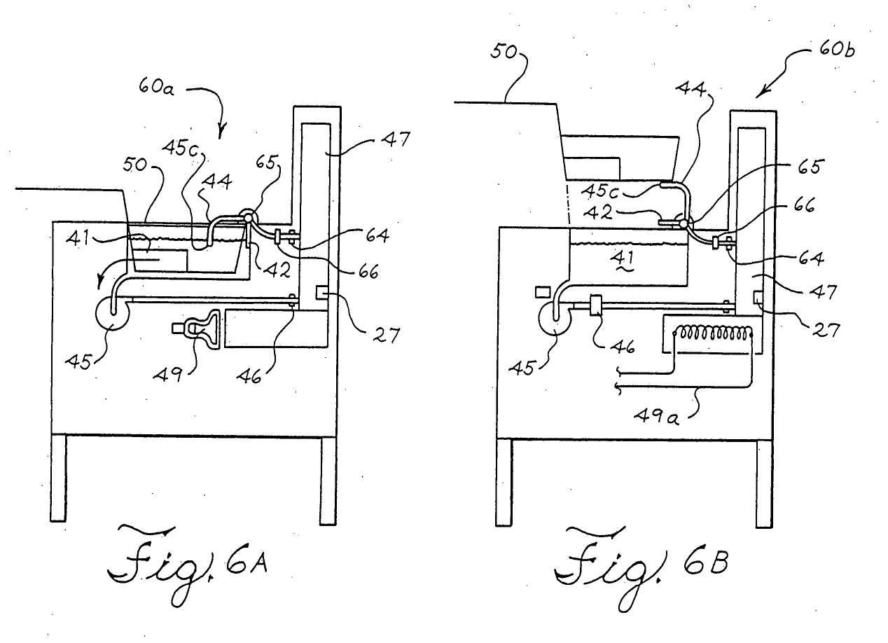

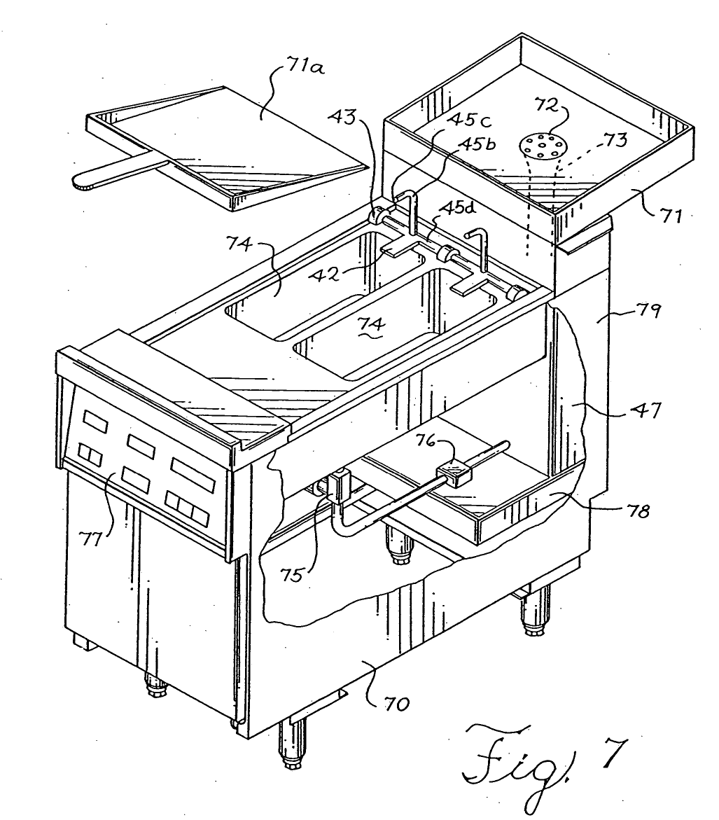

FIGS. 6a and 6b depict side views of embodiments of a fryer with this basket. FIG. 6a depicts a fryer 60a using a conventional natural gas or LP gas combustion system 49 with a heat exchanger 47 to heat cooking oil. When basket 50 is lowered into well 41, tab 42 as seen in FIG. 4 causes injector support 44 to pivot below the surface of the oil in the vat. Injector support 44 may include a nozzle and inlet piping as described above, and may also include a pump switch, a valve and a temperature sensor 64. In addition, there may be a pump switch 65, or a valve 66, or both, to regulate the flow of oil once the nozzle is lowered. Downward movement of nozzle 45c may close pump switch 65, if a proximity-type switch or interlock type switch is used. Temperature may be monitored by one or more temperature sensors 27, which may also be used to control combustion system 49.

Pump switch 65 may be operably connected to control panel 48 and microprocessor controller 48a. When pump switch 65 closes, it may activate pump 45 and may also activate valve 66, such as a solenoid valve, to open, and allow flow through injector support 44 and nozzle 45c. Nozzle 45c is preferably below the surface of the oil before the flow of oil begins. Once flow begins, oil will circulate through well 41 and the lower part of basket 50 in order to cook the food in the basket, while at the same time filtering the oil through the lower part of the basket.

Flow through the system may be sensed by flow sensor 46, which is operably connected to microprocessor controller 48a. Rather than using a flow controller, fryer 60a may use instead, or in addition, temperature sensors 27, pressure sensors, or other sensors to continually monitor flow of oil and temperature of the oil to ensure safe the operating condition of the fryer. In FIG. 6a and fryer 60a, oil flows from pump 45 through outlet piping while being monitored by flow sensor 46. The oil then flows into heat exchanger 47 where oil is heated by combustion system 49. The pump preferably flows only when basket 50 is lowered. Once the basket is lowered, injector support 44 also lowers, pump switch 65 closes, and valve 66, if present, opens. Pump 45 begins to pump oil, cooking any food in basket 50. The oil is filtered by the mesh and any filtering aids in the bottom portion of basket 50.

FIG. 6b depicts another fryer embodiment. Fryer 60b is heated by one of more electric heaters 49a while being monitored or controlled by one or more temperature sensors 27, at least one which preferably directly monitors oil temperature. In FIG. 6b, fryer 60b is shown with cooking basket 50 about to be lowered into well 41. Injector support 44 is thus in the raised position, pump switch 65 is open and valve 66 is preferably closed. When basket 50 is lowered, pump 45 will be activated, pumping oil from well 41 while being monitored by flow sensor 46, as oil flows from the pump into heat exchanger 47.

The design of the basket in FIGS. 4, 5 and 6a-6b uses the flow of oil from the pump, as well as the suction provided by the inlet of the pump, to insure a good flow of oil through the well and through the fryer basket. This helps to ensure that virtually all the oil in the well is kept moving during a cooking cycle, and is thus filtered. Note that basket 50 is designed with an impermeable upper portion to help preserve the partial vacuum to the greatest extent possible while the basket is immersed in the well.

Another way to operate fryer 60a, as depicted in FIG. 6a, is to pump the cooking oil from well 41 at the end of the cooking cycle. When the cooking cycle is complete, the combustion system 49 ceases heating and valve 66 closes, preventing the flow of oil from heat exchanger 47 to well 41. In other embodiments, the heat exchanger may be a reservoir or tank. The oil would then accumulate in heat exchanger or tank 47. As well 41 drains, the suction of the pump would continue to create a partial vacuum, draining the oil from well 41, basket 50, and the food that has just been cooked. The slight vacuum and the few seconds of time help to drain as much oil as possible from the basket and the food. The filtering portion of the basket retains at least some of the particles that are desirably removed from the oil.

Crumb dump for use with above embodiments

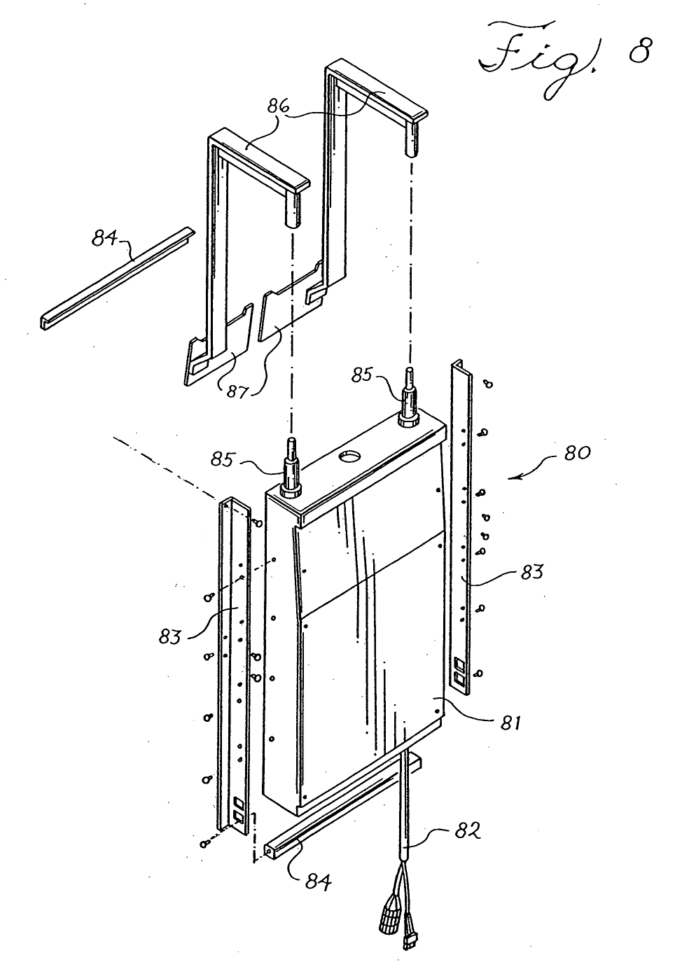

Other embodiments may include other features to assist the better performance of fryers that more frequently filter their oil and remove particulates. FIG. 7 depicts a fry cooker in which the oil is removed from the frying vat at the end of the cooking cycle. Fry cooker 70 includes at least one vat 74, pump 75, oil flow sensor 76, a control panel 77, heating system 78, and an oil reservoir 79. The fry cooker also includes a crumb dump assembly 71 atop the fry cooker. When an operator has completed a cooking cycle and has delivered the cooked items, the operator may shake out the remaining oil and particulates into crumb dump 71. Crumb dump 71 is preferably made from stainless steel sheet metal, and desirably includes a drain 72 near a central, low point of the crumb dump. Drain 72 may comprise a reasonably fine mesh screen for retaining particulates, while allowing drained oil to flow through and return to reservoir 79 or vat 74 through return line 73. A hand skimmer 71a may be used to skim the vat 74 and then dump the particulates into the crumb dump. Hand skimmer 71a preferably has a handle is includes mostly mesh made from fine stainless steel wire, such as a 30×150 Dutch weave. The skimmer should be able to retain 95-115 micron particles when a user skims it through a vat of oil or other cooking medium. Other wires in a coarser or finer mesh may be used as desired.

The crumb dump may also be used to simply hold frying baskets while they drain, so that particulates in the oil may be separated at the drain/filter portion while the oil returns to the vat or to a heat exchanger or reservoir. The crumb dump preferably is sufficiently high to hold baskets off their bottoms, allowing oil to more freely drain from the baskets.

Automatic basket lift for use with above embodiments

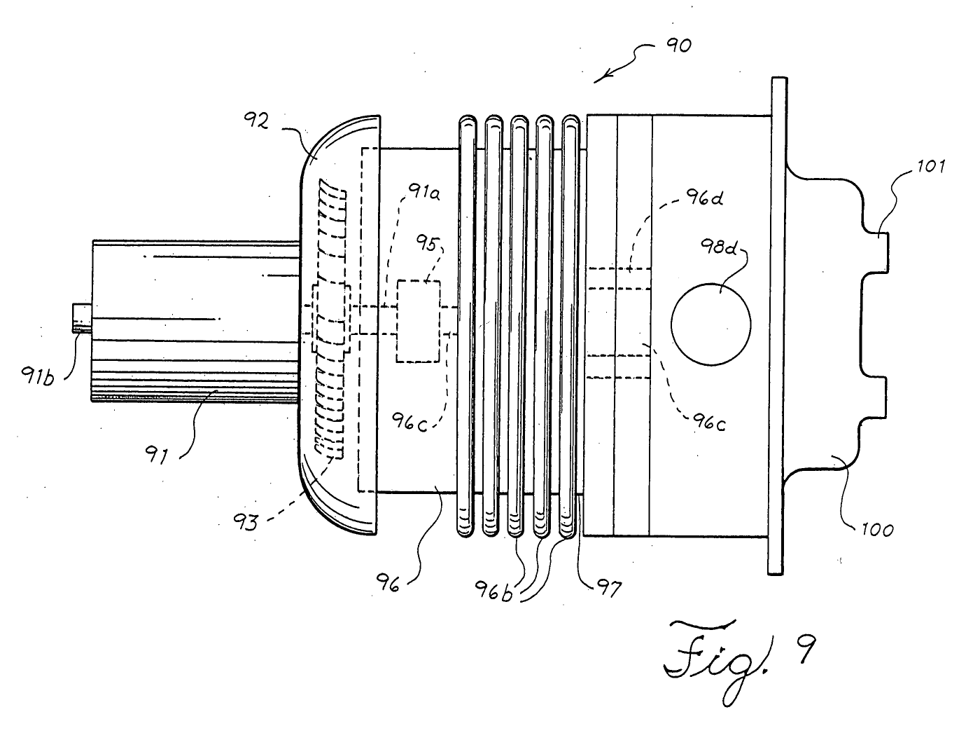

In addition to the techniques described above, a fryer may also include an automatic basket lift for lifting a fry basket from the hot oil after a cooking cycle. The basket lift typically has a separate lift for each cooking well or vat of the fryer. A basket lift is depicted in FIG. 8. Basket lift 80 is mounted to the rear of a fryer, such as any of the fryers depicted previously. Basket lift cabinet 81 includes all the controls necessary for operation, and is in communication with a controller for the fryer through wiring harness 82, which also supplies electrical power for the basket lift. Cabinet 81 may be mounted to the rear of the fryer with side mounts 83 and top and bottom mounts 84.

The basket lift includes a basket lift hanger 86 and basket mount 87 for each cooking well or vat of the fryer. A cooking basket is attached to basket mount 87 using a split hook or extension on the front portion of the cooking basket. The raising and lowering of each basket lift hanger is preferably separately controlled by the fryer controller. The basket lift hangers are raised and lowered by basket lift actuators 85. Actuators 85 may be electrically actuated by a motor and gear train within cabinet 81. Alternately the actuators may be hydraulically or pneumatically operated by a hydraulic pump or an air compressor with suitable valves and reliefs.

The basket lifts provide an automatic way of allowing oil to drain from the cooked food, thus preserving oil and allowing for food with less oil. The fryer controller will typically actuate the basket lift after the basket has been immersed in the cooking medium for a predetermined period of time. In other embodiments, the basket lift may be programmed to actuate after the food or the oil has achieved a certain temperature. For safety purposes, the controller may also cause the basket to automatically lift from the cooking medium after a longer set period of time has expired. If baskets with finer screens or a filter aid are used, the oil returned may be incrementally cleaner. After food is removed, the basket may be shaken or tapped to remove remaining particles into a crumb dump, as described above. This will help prevent the return of the particles while allowing for the return of additional oil for reuse.

High Temperature Pump and Motor

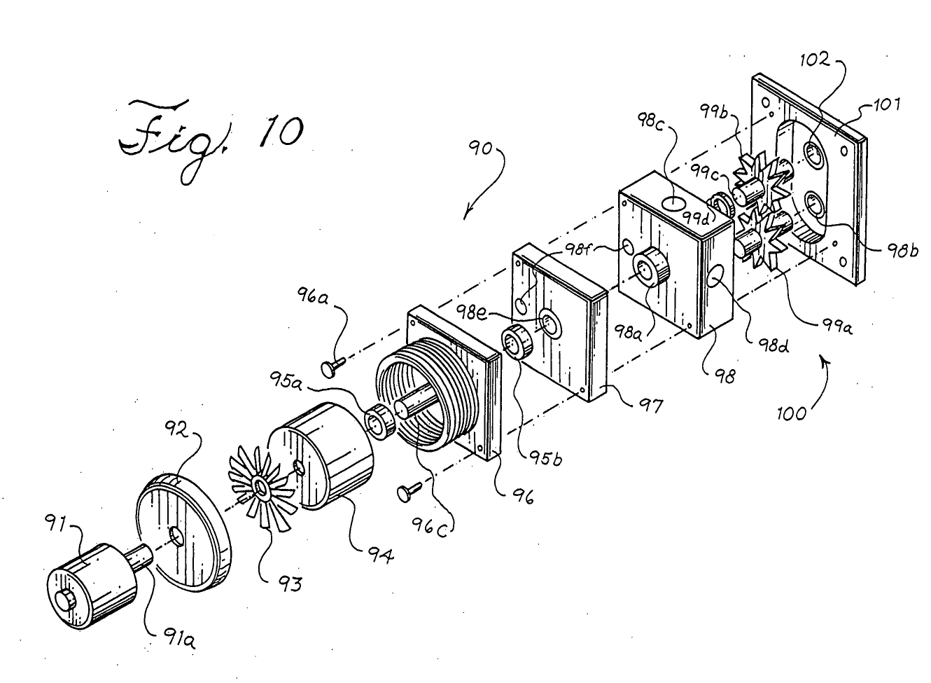

Fry cookers operate at high temperatures, and the motor and pump are among the most dynamic components that must operate at these high temperatures. FIGS. 9 and 10 depict a high temperature gear pump adapted for reliably pumping hot oil with under low flow, low head conditions. The pump and motor assembly includes a motor assembly 90 and a pump 100. The motor preferably has at least class B windings and is preferably capable of withstanding warm to hot temperatures for long periods of time. The temperature at the motor will depend on the heat generated in the pump, convected by the pump to the motor, and dissipated by operation of the motor and any available convection cooling.

Motor assembly 90 includes motor 91, shaft 91a and shaft extension 91b. Shaft extension 91b may be used to attach a hand crank (not shown) to rotate the motor and pump gears if crumbs prevent the pump from rotating. Motor 90 includes a cooling impeller or fan 93 and a protective shroud 92. A spacer or stand-off bracket 94 creates additional space between the motor and allows for further heat dissipation. Shaft coupler 95 joins motor shaft 91a and seal shaft 96c from seal block assembly 96. Another shaft coupler 95b joins the other side of seal shaft 96c to driving pump shaft 99c. Seal shaft 96c extends through seal block assembly 96 and mates via shaft couplers 95a, 95b to driving gear shaft 99c and motor shaft 91a. Seal shaft 96c mates with stationary seal portion 96d. Seal block assembly 96 preferably has extended surfaces or fins 96b for dissipating heat. Bolts or fasteners 96a allow assembly of pump 100.

The gear pump 100 operates by taking fluid into the spaces between driver gear 99b and idler gear 99a. Gear pump 100 includes pump body 98 and cover 101. The pump body 98 includes a fluid or hot oil inlet 98c and an outlet 98d. The gears mount into pump body 98 and cover 101 with bearings 98b and mounts 102, as shown for cover 101 only. Note also bearing 98e and seal 98a. In order to provide lubrication for the pump shaft seals, pump body 98 preferably includes several small orifices 98f as shown, preferably from about 0.005 inches to about 0.100 inches in diameter (about 0.13 mm to about 2.5 mm), more preferably from about 0.010 to about 0.060 inches in diameter (about 0.25 mm to about 1.5 mm). These orifices allow small amounts of hot oil to seep from the pump body to lubricate bearings 98b, 98e, and shaft seal 96c, 96d.

Control over the temperature of operation is the key to insuring long life of the pump and motor. Friction and heat generation from the motor in this application is much less than the heat load from the hot oil being pumped. It is contemplated that the hot oil will leave the cooking vat or other container at a temperature of at least 350° F., and perhaps hotter. The hot oil will heat the pump body and gears, and any other parts in direct contact with the oil. The pump and motor assembly are therefore designed to contain the heat in the pump to the greatest extent possible, and to dissipate any heat that conducts away from the pump in the direction of the motor.

The materials of construction are important to containing the heat in the pump and in dissipating the heat, while allowing long and reliable life for the pump and the motor. The parts in direct contact with the oil are preferably metallic, such as cast iron for the pump body and steel for the cover. The gears are preferably made from sintered iron, steel, or even high temperature thermoplastic materials. The term thermoplastic materials is intended to encompass both true thermoplastic materials, such as nylons, and also thermoset materials, such as phenolics, fluoropolymers, and polytetrafluoroethylene (PTFE) materials.

Stand-off bracket 94 and thermal barrier 97 may be as extensive as desired, each from about ⅛ of an inch thick to 1½ inches thick (about 3 mm to about 38 mm) or more. Standoff bracket 94 is preferably made from aluminum or steel. Thermal barrier 97 is preferably made from a high-temperature, thermally-insulating polymer material, such as a phenolic, a high-temperature polyester, and a fluoropolymer, such as PTFE. Seal block assembly 96 is preferably made from cast or machined aluminum, and preferably includes radial fins or extended surfaces 96b as shown. Inner shaft seal 99d, interfacing with shaft 99c, is preferably made from a high-temperature capable material, such as Viton® elastomer from DuPont. Kalrez® or Teflon® or other high temperature material may also be used, so long as the material is compatible with the particular oil or other cooking medium being pumped. A mechanical seal, such as one with ceramic or metallic elements, may also be used.

There are many embodiments of the invention. For instance, a fryer with a filtering capability as described above may include both a crumb dump and an automatic basket lift. Any number of additional sensors or safety features, well known to those skilled in restaurant and fryer arts, may also be used. It is intended that the foregoing detailed description be regarded as illustrative rather than limiting, and that it be understood that it is the following claims, including all equivalents, that are intended to define the spirit and scope of this invention.

What is claimed is:

1. A fryer, comprising:
a vat with a first portion for holding a cooking medium;
an energy source for heating the cooking medium;
a pump for circulating the cooking medium during a cooking cycle;
a control system including a microprocessor controller for controlling the energy source and the pump; and
at least one strainer for use in a second portion of the vat for filtering the cooking medium while the cooking medium is being pumped, wherein the strainer may be quickly removed and emptied while the medium is being pumped.

2. The fryer of claim 1, wherein the at least one strainer comprises two strainers, a first coarse strainer and a second finer strainer or filter.

3. The fryer of claim 1, wherein the at least one strainer is adapted to hold a replaceable filter aid for treating the cooking medium.

4. The fryer of claim 1, further comprising a sensor operably connected to the microprocessor controller for sensing a flow of oil in the fryer.

5. The fryer of claim 4, wherein the sensor is selected from the group consisting of a flow sensor, at least two temperature sensors, a pressure difference sensor, and two pressure sensors.

6. The fryer of claim 1, further comprising a basket lift mounted to a rear portion of the fryer.

7. The fryer of claim 1, further comprising a heat exchanger in fluid communication with an outlet flow from the pump and the vat.

8. The fryer of claim 1, further comprising a crumb dump mounted to a rear portion of the fryer.

9. A method of operating a fryer according to claim 1, the method comprising:
heating the cooking medium to a temperature suitable for cooking food;
pumping the cooking medium to achieve a flow from the first portion to the second portion;
straining the cooking medium by flowing the cooking medium through at least one strainer; and
emptying the strainer.

10. The method of claim 9, treating the cooking medium with a replaceable filter aid in the at least one strainer.

11. A fryer, comprising:
a vat for holding a cooking medium;
an energy source for heating the cooking medium;
a pump for automatically circulating the cooking medium during a cooking cycle;
a control system for controlling at least the energy source; and
a cooking basket with a sealing portion and a straining portion, wherein the cooking basket collects cooking particles from the medium during the cooking cycle.

12. The fryer of claim 11, further comprising a heat exchanger in fluid communication with an outlet flow from the pump.

13. The fryer of claim 10, further comprising a basket lift mounted to a rear of the fryer.

14. The fryer of claim 10, further comprising a flow sensor in communication with the control system.

15. The fryer of claim 10, further comprising a pivotable oil pipe near the vat, wherein placing a basket into the fryer pivots the pivotable oil pipe and begins the cooking cycle.

16. The fryer of claim 10, further comprising a crumb dump mounted to a rear portion of the fryer.

17. The fryer of claim 10, wherein the straining portion is adapted to hold a replaceable filter aid for treating the cooking medium.

18. A method of operating a fryer according to claim 10, the method comprising:
heating the cooking medium to a temperature suitable for cooking food;
automatically pumping the cooking medium to achieve a flow through the cooking basket;
straining the cooking medium by flowing the cooking medium through the straining portion of the cooking basket; and
emptying the straining portion.

19. The method of claim 18, further comprising treating the cooking medium with a replaceable filter aid in the straining portion.

20. A fryer basket, comprising:
an upper portion for sealing;
a lower portion for filtering;
a bottom portion for filtering; and
a handle connected to at least the upper and lower portions.
